(19) United States
(12) Patent Application Publication
(10) Pub. No.: US 2014/0320498 A1
(43) Pub. Date: Oct. 30, 2014

(54) TERMINAL DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Daisuke AJITOMI, Tokyo (JP); Keisuke MINAMI, Kawasaki-shi (JP); Masataka GOTO, Yokohama-shi (JP)

(73) Assignee: KABUSHIKI KAISHA TOSHIBA, Tokyo (JP)

(21) Appl. No.: 14/205,765

(22) Filed: Mar. 12, 2014

(30) Foreign Application Priority Data
Apr. 26, 2013 (JP) 2013-094534

(51) Int. Cl. G06T 11/20

(52) U.S. Cl. CPC G06T 11/206
USPC 345/440

(57) ABSTRACT

According to an embodiment, a terminal device includes a memory unit, a managing unit, a detecting unit, a reference assigning unit, a reference deleting unit, a determining unit, and a changing unit, and a deleting unit. The detector detects that a first graph element read by a processing unit is updated before the start of transactions being executed by the processing unit. The determining unit determines that a first graph element is updated before the start of the oldest transaction being executed and does not have reference information assigned thereto. The first graph element is pointed to by link information of a second information. The changing unit changes the link information of the second graph element to point to a third graph element, or delete the link information. The deleting unit deletes the first graph element.

### CROSS-REFERENCE TO RELATED APPLICATIONS

This application is based upon and claims the benefit of priority from Japanese Patent Application No. 2013-094534, filed on Apr. 26, 2013; the entire contents of which are incorporated herein by reference.

### FIELD

Embodiments described herein relate generally to a terminal device, an information processing method, and a computer program product.

### BACKGROUND

Typically, for example, graph databases are known as databases aimed at enabling high-speed searching of pertinent information. Herein, in order to ensure that, even when data is updated as a result of executing a write transaction, a read transaction that was started prior to data updating does not read the post-updated data; it is necessary to hold the pre-updating old data.

However, in the conventional method, if the pre-updating data is stored in a readable manner, then it leads to an increase in the required memory size.

### BRIEF DESCRIPTION OF THE DRAWINGS

FIGS. 1A and 1B are diagrams illustrating isolation levels of transactions with respect to nodes of graph structure data;

FIG. 2 is a diagram illustrating graph structure data in which unnecessary references occur due to the holding of pre-updating data;

FIG. 3 is a block diagram illustrating an exemplary configuration of a terminal device according to an embodiment;

FIG. 4 is a diagram illustrating a structure of manipulation information and illustrating states of edges before and after change of link information;

FIG. 5 is an activity diagram illustrating an example of operations performed in the terminal device in the case of executing a write transaction;

FIG. 6 is an activity diagram illustrating an example of operations performed in the terminal device in the case of executing a read transaction;

FIG. 7 is an activity diagram illustrating an example of operations performed in the terminal device in the case of performing garbage collection; and

FIG. 8 is a diagram illustrating a specific example of operations (a processing sequence) performed in the terminal device.

### DETAILED DESCRIPTION

According to an embodiment, a terminal device includes a memory unit, a managing unit, a detector, a reference assigning unit, a reference deleting unit, a determining unit, a changing unit, and a deleting unit. The memory unit is configured to store therein graph elements each representing a node or an edge constituting graph structure data. The managing unit is configured to generate and delete a processing unit which executes transactions each performing data manipulation on an individual basis with respect to the graph elements stored in the memory unit. The detector is configured to detect that the graph element read by the processing unit is updated before the start of transaction being executed by the processing unit. The reference assigning unit is configured to assign reference information to the graph element detected by the detector. The reference deleting unit is configured to, at the end of a transaction which has performed manipulation with respect to the graph element having reference information assigned thereto by the reference assigning unit, delete the reference information assigned to the graph element which has been manipulated. The determining unit configured to determine that a first graph element is updated before the start of the oldest transaction being executed and does not have reference information assigned thereto. The first graph element is pointed to by link information of a second information. The changing unit is configured to change the link information of the second graph element to point to a third graph element, or delete the link information. The deleting unit is configured to delete the first graph element.

Background

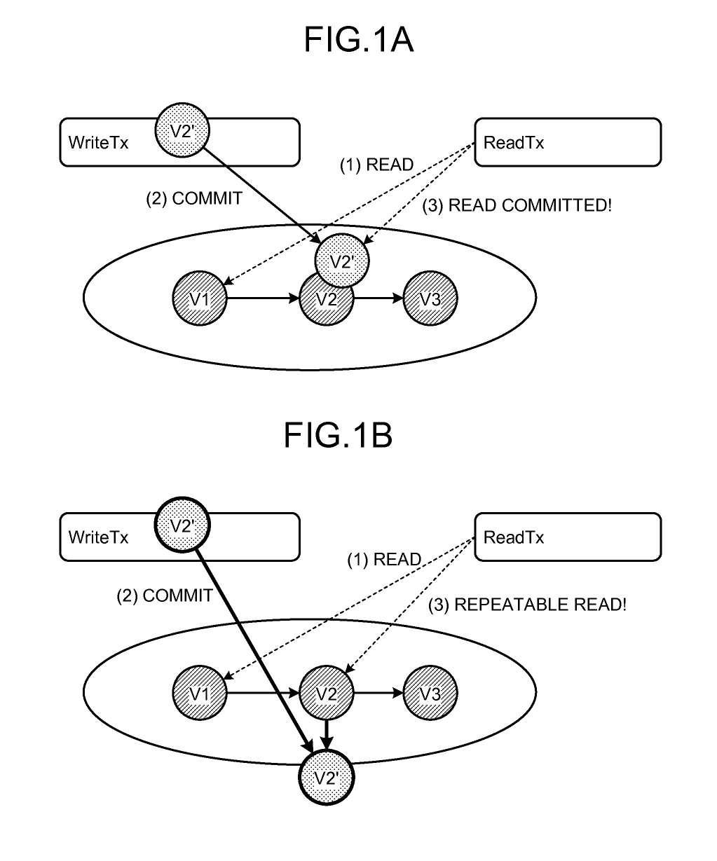

Firstly, the explanation is given about the background that led to inventing a terminal device according to an embodiment. FIGS. 1A and 1B are diagrams illustrating isolation levels of transactions with respect to nodes of graph structure data. FIG. 1A indicates Read Committed, and FIG. 1B indicates Repeatable Read. In each of FIG. 1A and FIG. 1B, with respect to graph structure data including nodes V1, V2, and V3; the node V2 is updated to a node V2′ by a write transaction (writeTx), and a read transaction (readTx) is executed.

In FIG. 1A, because of Read Committed, in a read transaction (readTx), the latest data that has been defined is read at all times. In FIG. 1B, because of Repeatable Read, in a read transaction (readTx), target data for reading is read at all times.

Thus, depending on the transaction isolation level, it becomes possible to change the degree of data consistency that is maintained in order to reduce the latency time.

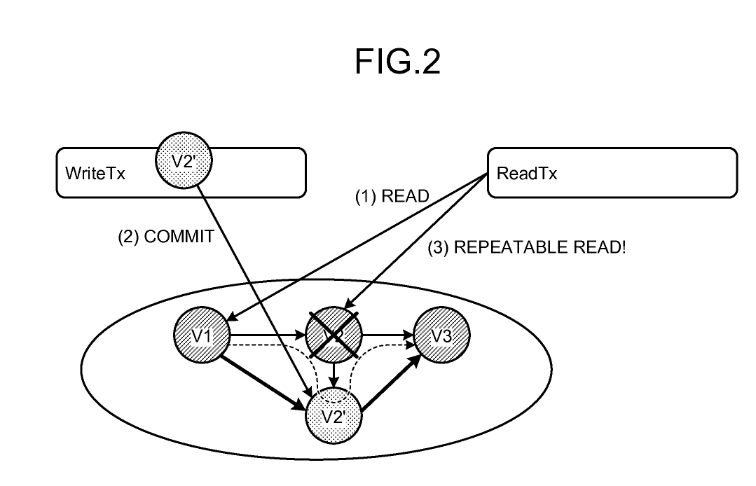

FIG. 2 is a diagram illustrating graph structure data in which unnecessary references occur due to the holding of pre-updating data (old data). In FIG. 2, because of Repeatable Read, the old data (V2) is held. Since the old data is held, the updated data is sometimes referred to via the old data (V2). In this case, the reading becomes slower, and the memory size becomes larger. In that regard, there has been a demand to enable reading of the pre-updating data as well as to enable achieving reduction in the required memory size.

### Embodiment

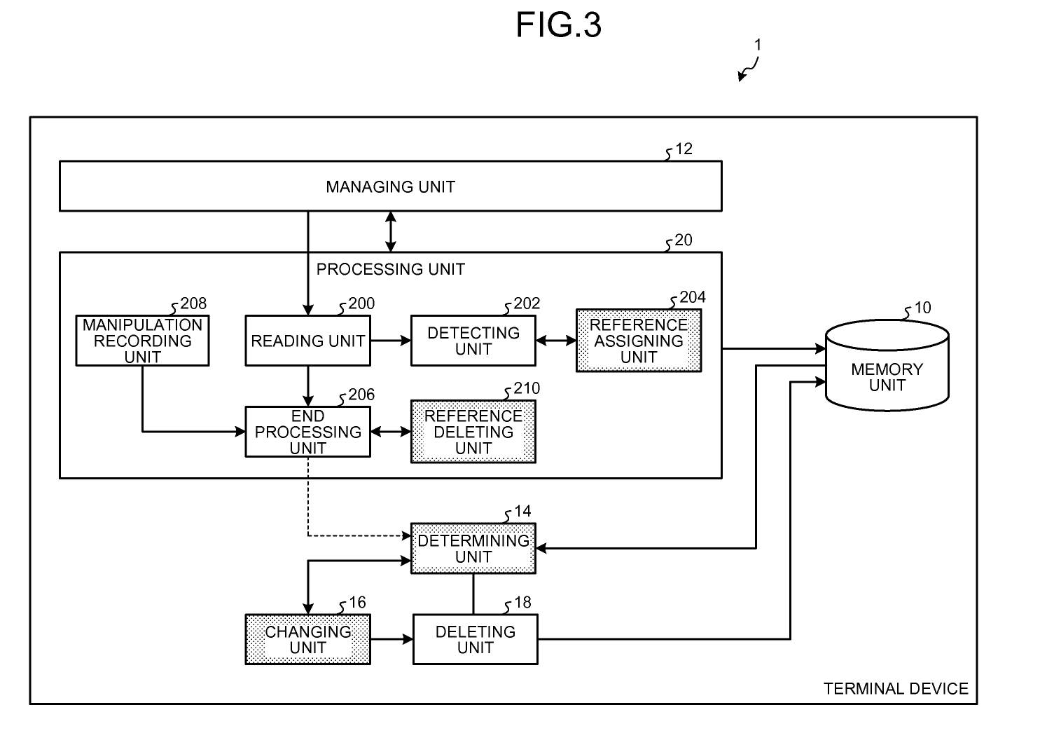

FIG. 3 is a block diagram illustrating an exemplary configuration of a terminal device 1 according to an embodiment. The terminal device 1 is implemented using, for example, a general-purpose computer. That is, the terminal device 1 has the functions of a computer that includes a central processing unit (CPU), a memory device, and a communication interface. Alternatively, the terminal device 1 can be implemented using a server device or using a digital device such as a personal computer (PC), a digital television set, a hard disk recorder, a slate PC, or a smartphone.

As illustrated in FIG. 3, the terminal device 1 includes a memory unit 10, a managing unit 12, a determining unit 14, a changing unit 16, and a deleting unit 18. The memory unit 10 is configured with, for example, a single hard disk drive (HDD) or a plurality of HDDs. Alternatively, the memory unit 10 can be a nonvolatile auxiliary memory device (such as a solid state drive (SSD), a flash memory, or a magnetic random access memory (MRAM)), or can be a main memory device. The managing unit 12, the determining unit 14, the changing unit 16, and the deleting unit 18 can be implemented using either hardware circuitry or using software executed in the CPU.

The memory unit 10 is used to store therein graph elements (elements) that represent nodes or edges constituting graph structure data. Moreover, the memory unit 10 can also be used to store therein data elements containing data containers. For example, a data container is a data management mechanism for providing addition/updating/deletion/acquisition (retrieval) of a plurality of pieces of data.

The managing unit (a transaction managing unit) 12 generates and deletes a processing unit (a transaction processing unit) 20 (described later), as well as manages the processing unit 20. In the case of generating the processing unit 20, the managing unit 12 assigns identification information (a transaction ID) that enables unique identification of the processing unit 20. Moreover, at least during the period in which the processing unit 20 exists, the managing unit 12 holds the assigned transaction ID in a corresponding manner to reference information for the processing unit 20. Furthermore, with respect to a query in which the transaction ID serves as the key, the managing unit 12 sends a reply including the state of that transaction and including the processing completion time. Moreover, from among the transactions that are being concurrently executed, the managing unit 12 identifies the oldest transaction.

The processing unit 20 includes a reading unit 200, a detecting unit 202, a reference assigning unit 204, an end processing unit 206, a manipulation recording unit 208, and a reference deleting unit 210. Meanwhile, the transactions executed by the processing unit 20 are of two types. A write transaction performs reading as well as manipulations (addition/updating/deletion). A read transaction performs only reading.

A write transaction performs a plurality of manipulations (transactions) with respect to the graph structure data, which is stored in the memory unit 10, while maintaining consistency. For that, the processing unit 20 takes one of the following five states, namely, an execution state, a commit preparation state, a commit completion state, an abort state, and an end state.

The execution state is a state in which manipulations are performed with respect to nodes, edges, properties in the nodes/edges, and outgoing and incoming edges in the nodes. At the point of time when the processing unit 20 is generated by the managing unit 12, the processing unit 20 is in the execution state. Herein, a series of manipulations is not committed (not defined) and can be rolled back. During an operation of obtaining a target for manipulations, the processing unit 20 detects the existence of deletable old data using the reading unit 200, the detecting unit 202, and the reference assigning unit 204; and temporarily protects the data from being deleted.

The commit preparation state is a state in which a series of manipulations is completed and a manipulation completion time is obtained. The processing unit 20 checks the changes made by other transactions performed during the period starting from a manipulation start time to the manipulation completion time, and determines whether or not commitment can be actually given.

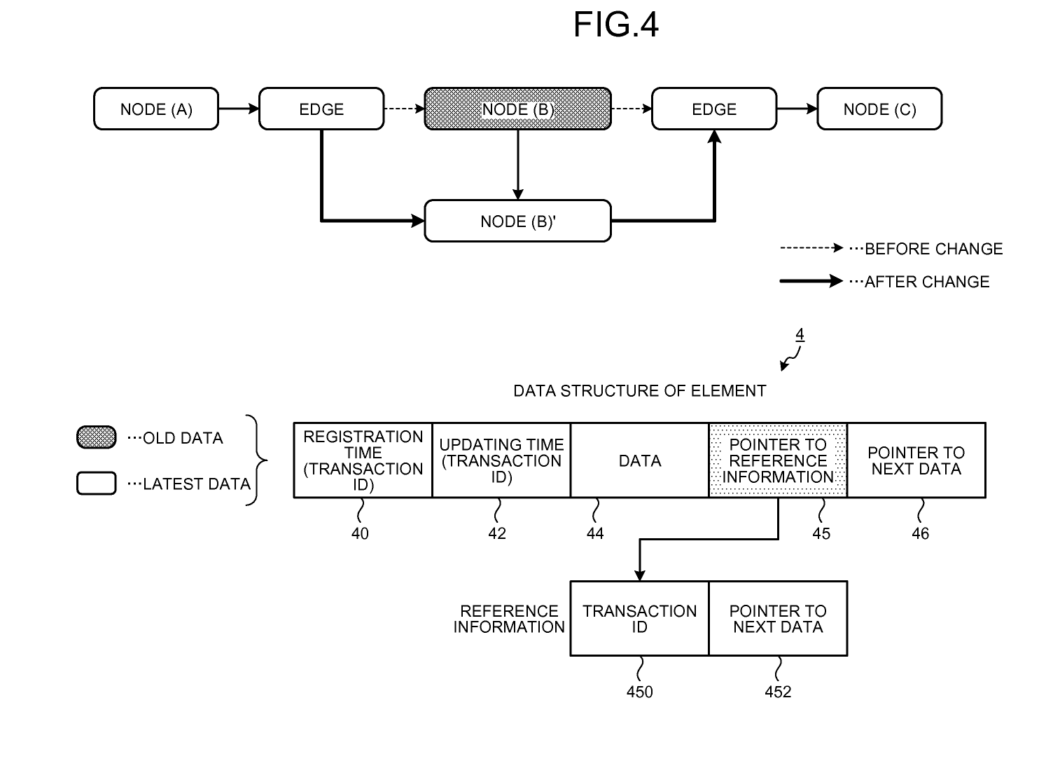

The commit completion state is a state in which a series of manipulations is defined when the check result indicates a committable condition. Herein, the processing unit 20 writes the manipulation completion time and records data for deletion in all pieces of manipulation information 4 (described later with reference to FIG. 4). Moreover, the processing unit 20 can write a log of the series of manipulations in a nonvolatile memory area, and secure the persistence of commit data. Lastly, the processing unit 20 terminates.

The abort state is a state in which an executed manipulation is cancelled in the case when the check result indicates a non-committable condition, or in the case when there is competition for writing, or in the case when an upper level application performs cancellation. Then, the processing unit 20 deletes (rolls back) all pieces of the manipulation information 4, which are recorded by the manipulation recording unit 208 (described later), and terminates.

The end state is a state in which the post-processing related to the manipulations is completed in the commit completion state and the abort state. The processing unit 20 cancels the protection for the deletable old data using the end processing unit 206 and the reference deleting unit 210. Then, the processing unit 20 holds state information mentioned above.

Meanwhile, a read transaction takes any one of an execution state and an end state.

The execution state is a state in which reading is performed with respect to the graph structure data. The processing unit 20 detects the presence of deletable old data using the reading unit 200, the detecting unit 202, and the reference assigning unit 204; and temporarily protects the data from being deleted.

The end state is a state in which reading of target graph elements is completed in entirety. The processing unit 20 cancels the protection for the deletable old data using the end processing unit 206 and the reference deleting unit 210.

As described above, the processing unit 20 includes the reading unit 200, the detecting unit 202, the reference assigning unit 204, the end processing unit 206, the manipulation recording unit 208, and the reference deleting unit 210.

The manipulation recording unit 208 performs substantive manipulations during the execution state of a write transaction. For example, the manipulation recording unit 208 records the manipulation information 4 (see FIG. 4) at a manipulation location, and simultaneously records manipulation location information in the processing unit 20. Firstly, the operation performed by the manipulation recording unit 208 is basically either one of “addition”, “updating”, and “deletion”. However, the manipulation recording unit 208 can be configured to perform manipulations not including updating.

For example, when the data stored in the memory unit 10 is graph structure data, the manipulation recording unit 208 performs addition/deletion at the level of nodes/edges and performs addition/updating/deletion at the level of container data (property information, or edge information held by nodes) belonging to nodes/edges.

Meanwhile, as the manipulation for “addition”, the manipulation recording unit 208 can be configured to perform either only generation or generation as well as appending.

In the execution state, the manipulation recording unit 208 records the manipulation information 4 (described later) at a manipulation location. Moreover, the manipulation recording unit 208 records, in the processing unit 20, manipulation location information that indicates the manipulation location. The manipulation location information serves as a pointer for the purpose of referring to the manipulation information 4 and, for example, is a pointer to the pre-updating data (the old data).

The reading unit 200 reads graph elements until no target for reading is remaining. Herein, in the case of performing the reading, the reading unit 200 makes use of the manipulation start time, which is obtained at the start of a transaction, and obtains the latest data while skipping future data and the old data.

In the case of skipping the old data, the terminal device 1 detects whether or not the old data is the target data for deletion and protects the data if necessary. More particularly, the processing unit 20 performs the following operations.

If the manipulation start time of a piece of data is between a registration time and an updating time in the data structure described later with reference to FIG. 4, then the reading unit 200 considers that set of data to be the latest data in the transaction and obtains the data. Moreover, if the manipulation start time of a piece of data is earlier than the registration time, then the reading unit 200 considers the piece of data as data generated in future for the transaction and considers the data to be nonexistent. On the other hand, if the manipulation start time of a piece of data is later than the updating time, then the reading unit 200 considers the piece of data to be the old data which has been deleted in the past for the transaction and sends the data to the detecting unit 202 (described later). Moreover, the reading unit 200 determines the presence or absence of competition among the transactions. If there is no competition, then the reading unit 200 obtains the data. However, when there is competition, the reading unit 200 aborts the transaction. For example, in a data structure of an element described later with reference to FIG. 4, if a transaction ID is included in a second area 42, the determination for competition is performed according to the state of the transaction. More particularly, in the abort state, the reading unit 200 considers the piece of data to be the latest data and obtains the data. In the execution state, the reading unit 200 considers that there is competition which may cause a loss in the data consistency, and thus aborts. In the commit completion state, the reading unit 200 considers the data to be the updated (deleted) data and moves to checking the next piece of data. In the commit preparation state, the behavior of the reading unit 200 changes depending on whether or not speculative execution is allowed. In the case when speculative execution is allowed, in an identical manner to the commit completion state, the reading unit 200 moves to checking the next piece of data. On the other hand, in the case when speculative execution is not allowed, the reading unit 200 considers that there is competition, and thus aborts.

The detecting unit 202 detects the old data (i.e., detects the data for which the updating time is set). More particularly, the detecting unit 202 detects the old data by detecting the fact that the data read by the reading unit 200 is updated before the manipulation start time of data.

The reference assigning unit 204 assigns reference information (see FIG. 4) to the target old data for deletion that is detected by the detecting unit 202, and records in the transaction the pointer to the old data.

The end processing unit 206 follows the pointer to the old data as recorded by the reference assigning unit 204. Then, for example, once the reference deleting unit 210 atomically deletes each piece of reference information, the end processing unit 206 ends the operations. Meanwhile, when the number of pieces of reference information becomes equal to zero due to the deletion of the reference information, the end processing unit 206 can be configured to drive the determining unit 14 (described later) for the purpose of garbage collection.

Herein, the determining unit 14, the changing unit 16, and the deleting unit 18 constitute a functional block (a garbage collection unit) for performing garbage collection (i.e., deleting the deletable old data).

The determining unit 14 obtains the start time of the oldest transaction from among the transactions that are being concurrently executed. Then, if the updating time of the target old data for deletion determination (i.e., if the deletion time) is earlier than the start time, then the determining unit 14 determines that the transaction is deletable and requests the changing unit 16 to perform change (in the case of updating) or deletion (in the case of deletion).

The changing unit 16 receives a request from the determining unit 14, and accordingly either changes link information of an adjacent graph element (a second graph element in claims), which points to the old data (a first graph element in claims), to point to an atomically updated graph element (a third graph element in claims); or deletes the link information. As far as a graph element (a node or an edge) is concerned; a node has the link information pointing to an adjacent edge, and an edge has the link information pointing to an adjacent node (in FIG. 4, pieces of link information are indicated by arrows. In reality, a piece of link information indicates an address in a memory or a nonvolatile memory at which the adjacent element is stored. Thus, as far as the implementation is concerned, a piece of link information is expressed using a pointer, a reference, or an offset value in a file). The changing unit 16 follows the link information pointing to the next data in which the old data is included, and atomically changes the link information of the adjacent element, which points to the old data, to point to the next data.

Meanwhile, in the case when the next data does not exist (i.e., when data is to be deleted); if the adjacent element is an edge (and the old data is a node), then the changing unit 16 sets the updating time of the old data to the updating time of the edge and records the edge as the target old data for deletion. This edge can either be headed to the old data (i.e., an input edge from the perspective of the old data) or be an edge headed outward from the old data (i.e., an output edge). In the case when an operation to follow an input edge (in the reverse direction) is not supported, it is also possible to implement a method in which the output edge and the node are treated as a unit and are deleted at the same time. On the other hand, in the case when the operation to follow an input edge is supported, the link information (an input edge container) to the input edge is present in the node. Hence, for example, as described above, the node is treated as the old data in a stepwise manner and is entered in garbage collection. Moreover, when the adjacent element is a node (i.e., when the old data is an edge), the changing unit 16 atomically deletes the link information to the old data (more particularly, sets information such as “NULL” indicating that there is no link destination).

The deleting unit 18 actually deletes the old data from which the changing unit 16 has removed all adjacent element information.

Given below is the detailed explanation of the manipulation information 4. FIG. 4 is a diagram illustrating a structure of the manipulation information 4 and illustrating states of edges before and after the change of link information. As illustrated in FIG. 4, the manipulation information 4 includes a first area 40, the second area 42, a third area 44, a fourth area 45, and a fifth area 46. It is assumed that the data (operation contents: values) is written in the third area 44. When the data is updated, it is assumed that a new piece of manipulation information 4 is written in the third area 44 (appending type). When the data is no more read, it is assumed that the manipulation information 4 is retrieved.

The first area 40 is an area in which the manipulation recording unit 208 writes the completion time (the registration time) at the time when, for example, a transaction for writing data in the third area 44 is completed. However, during the period in which the transaction is executed and then completed, in the first area 40 is written the identification information (the transaction ID) that enables identification of the transaction being executed.

The second area 42 is an area in which the manipulation recording unit 208 writes the updating time at the time when a transaction for updating the data written in the third area 44 is completed. However, during the period in which the transaction is executed and completed, in the second area 42 is written another value. For example, when the transaction for updating the data written in the third area 44 is not executed, in the second area 42 is written a value (for example, “0”) which indicates that the data written in the third area 44 is valid. Moreover, during the period in which the transaction for updating the data written in the third area 44 is executed and then completed, in the second area 42 is written the identification information (the transaction ID) that enables identification of the transaction being executed.

The third area 44 is an area in which, as described above, the manipulation recording unit 208 records the data (values) subjected to manipulation.

The fourth area 45 is an area in which the manipulation recording unit 208 (or the reference assigning unit 204) writes the pointer to the reference information. Herein, the reference information contains a transaction ID 450 and a pointer 452 to the next data. Moreover, there can be a plurality of pieces of reference information.

The fifth area 46 is an area in which the manipulation recording unit 208 writes the pointer to the next data (i.e., the data to be updated next). If the next data does not exist, then it is assumed that in the fifth area 46 is written information (for example, “NULL”) which indicates that the next data does not exist.

The manipulation information 4 has the same data structure in the old data and the latest data such as elements. For example, in the case of adding a graph element, the manipulation recording unit 208 records the transaction ID at the start time of a new data entry point of the upper level container to which the graph element belongs; and records the new graph element in the data. Herein, the manipulation recording unit 208 writes in the second area 42 the information (for example, “0”) which indicates non-updating (valid); and writes in the fifth area 46, as an initial value, the information (for example, “NULL”) which indicates that the next data does not exist.

Moreover, in the case of adding container data, the manipulation recording unit 208 records the transaction ID at the start time of a new data entry point of the data container to which the container data belongs; and records the new container data in the data. Herein, the manipulation recording unit 208 writes in the second area 42 the information (for example, “0”) which indicates non-updating (valid); and writes in the fifth area 46, as an initial value, the information (for example, “NULL”) which indicates that the next data does not exist.

In the case of updating a graph element, the manipulation recording unit 208 records the transaction ID in the second area 42 of the old graph element (which is to be updated), and records the address of the updated data element in the fifth area 46 of the old graph element (which is to be updated). Then, the manipulation recording unit 208 records the transaction ID in the first area 40 of the updated data element, and records the updated data element in the third area 44 of the updated data element.

In the case of updating the container data, the manipulation recording unit 208 records the transaction ID in the second area 42 of the old container data (which is to be updated), and records the address of the updated container data in the fifth area 46 of the old container data (which is to be updated). Then, the manipulation recording unit 208 records the transaction ID in the first area 40 of the updated container data, and records the updated container data in the third area 44 of the updated container data.

In the case of deleting a graph element, the manipulation recording unit 208 records the transaction ID in the second area 42 of the old graph element (which is to be deleted).

In the case of deleting container data, the manipulation recording unit 208 records the transaction ID in the second area 42 of the old container data (which is to be deleted).

Meanwhile, in the commit completion state, the transaction ID is replaced by the manipulation completion time. In contrast, in the abort state, the transaction ID is returned to the initial value (such as NULL). Herein, it is assumed that, when the transaction ID has the initial value, it does not represent the manipulation information 4 but represents the latest graph element that can be the target for updating or represents the latest container data. Meanwhile, in the manipulation information 4, it is also possible to have an area for specifying the manipulation type such as addition/updating/deletion. Moreover, it is possible to have an area for setting a deletion flag.

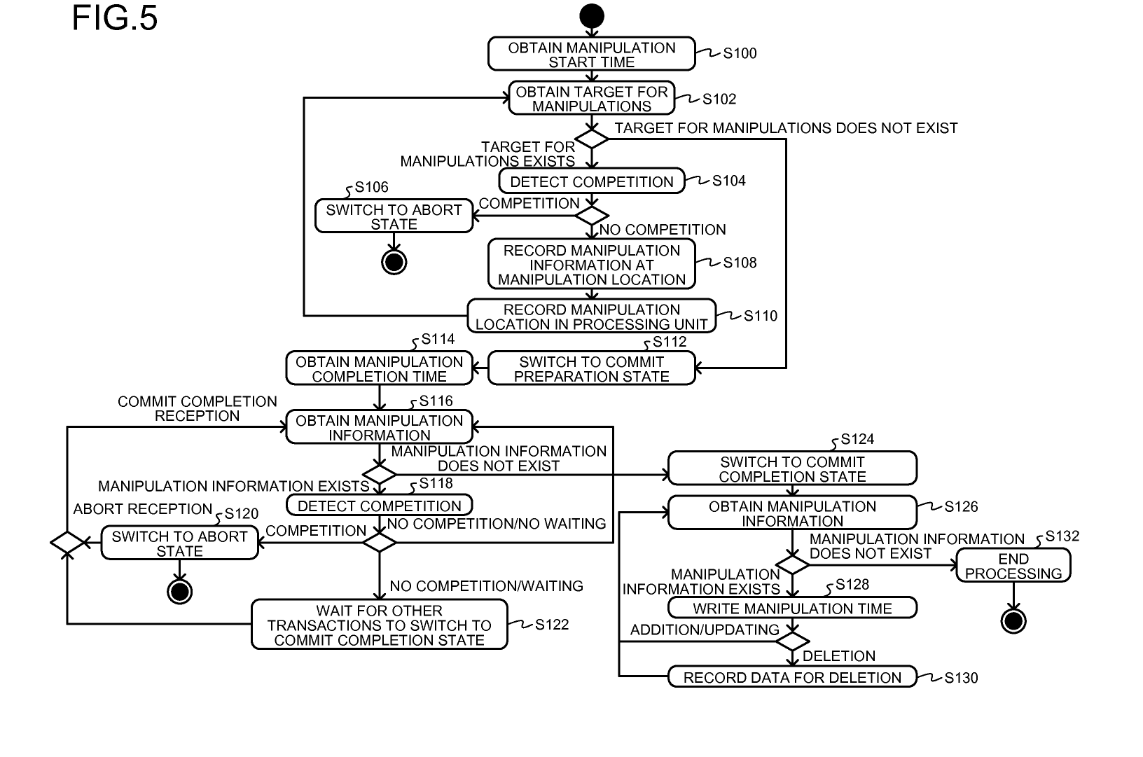

Given below is the explanation of the operations performed in the terminal device 1. FIG. 5 is an activity diagram illustrating an example of operations performed in the terminal device 1 in the case of executing a write transaction. Firstly, the processing unit 20 obtains the manipulation start time of the transaction (S100).

Then, the processing unit 20 obtains the target for manipulations of the transaction (S102). Herein, in order to skip the old data and to obtain the latest data, the processing unit 20 makes use of the manipulation start time obtained at S100.

If there is no target for manipulations, then the processing unit 20 switches the transaction to the commit preparation state (S112). On the other hand, if the target for manipulations is present, the processing unit 20 detects whether or not there is competition (S104).

When the competition is detected to be present, the processing unit 20 switches the transaction to the abort state (S106).

On the other hand, if there is no competition, then the processing unit 20 records the manipulation information 4 at the manipulation location (S108) and records the manipulation location in the processing unit 20 (S110).

Subsequently, the processing unit 20 obtains the manipulation completion time of the transaction (S114). Herein, as the manipulation completion time, the processing unit 20 considers the time at which the transaction switches to the commit preparation state. Then, the processing unit 20 obtains the manipulation information 4 (S116). If the manipulation information 4 does not exist, then the processing unit 20 switches the transaction to the commit completion state (S124). On the other hand, when the manipulation information 4 is present, the processing unit 20 detects whether or not there is competition (S118).

If there is no competition and no waiting, then the processing unit 20 newly obtains the manipulation information 4 (S116). However, if there is no competition but if there is waiting, then the processing unit 20 waits for the other transactions to switch to the commit completion state (S122). Meanwhile, if there is competition, then the processing unit 20 switches the transaction to the abort state (S120).

While waiting for the other transactions to switch to the commit completion state, if the processing unit 20 receives an abort notification, it switches the transaction to the abort state (S120). Moreover, while waiting for the other transactions to switch to the commit completion state, if the processing unit 20 receives a commit completion notification, it newly obtains the manipulation information 4 (S116).

After switching the transaction to the commit completion state (S124), the processing unit 20 obtains new manipulation information 4 (S126). The subsequent operations are performed for the purpose of registering the transaction for garbage collection. When the manipulation information 4 is present, the processing unit 20 only writes the manipulation completion time (S128). On the other hand, when the manipulation information 4 does not exist, the processing unit 20 performs end processing (S132).

When the written data at the manipulation completion time indicates that the written data is to be deleted, the processing unit 20 records the data for deletion (S130). Herein, when writing of the updating time is performed and when the pointer to the next data is “NULL”, the processing unit 20 considers that deletion is to be performed. When the written data at the manipulation completion time indicates that a node (or an edge) is to be added or updated, the processing unit 20 obtains new manipulation information 4 (S126).

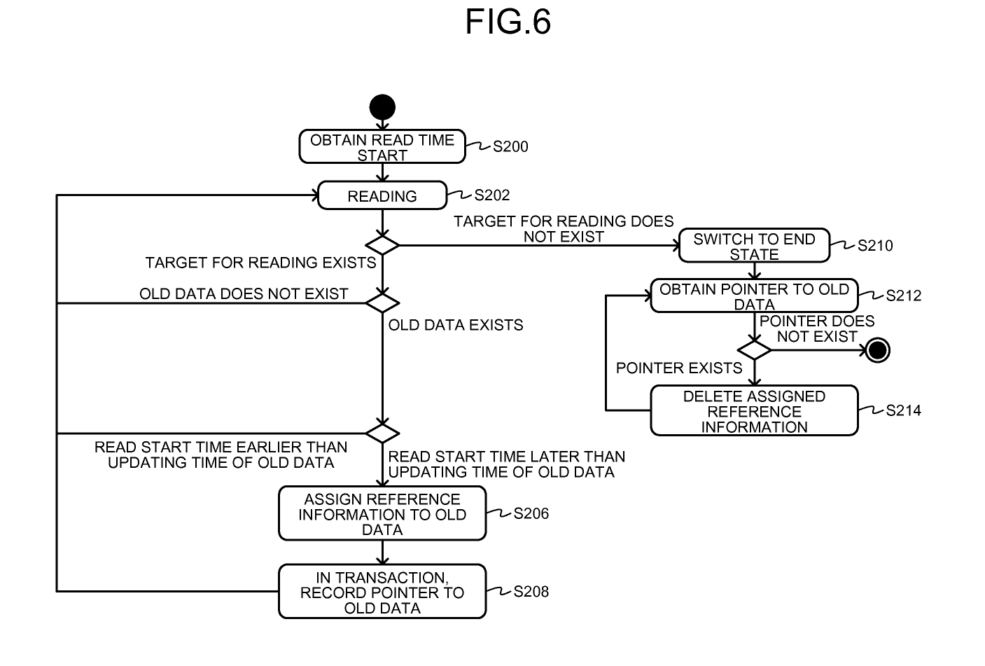

FIG. 6 is an activity diagram illustrating an example of operations performed in the terminal device 1 in the case of executing a read transaction. Firstly, the processing unit 20 obtains a read start time (S200). Then, the reading unit 200 performs reading (S202). Meanwhile, if there is no target for reading, the reading unit 200 notifies the end processing unit 206 to switch to the end state.

When the target for reading is present and the old data is present, the detecting unit 202 compares the updating time of the old data with the read start time of the corresponding transaction. However, when the target for reading is present but the old data does not exist, the detecting unit 202 notifies the reading unit 200 to perform reading.

When the read start time is later than the updating time of the old data, the detecting unit 202 notifies the reference assigning unit 204 about the same. In contrast, when the read start time is earlier than the updating time of the old data, the detecting unit 202 notifies the reading unit 200 to perform reading.

The reference assigning unit 204 receives a notification from the detecting unit 202, and assigns reference information to the old data (S206). Moreover, the reference assigning unit 204 records the pointer to the old data in the transaction (S208).

The end processing unit 206 receives a notification from the reading unit 200, and switches the transaction to the end state (S210). Moreover, the end processing unit 206 obtains the pointer to the old data (S212). When the pointer is present, the end processing unit 206 notifies the reference deleting unit 210 about the same. When the pointer does not exist, the end processing unit 206 ends the operations.

When the end processing unit 206 obtains the pointer to the old data, the reference deleting unit 210 deletes the reference information that was assigned by the reference assigning unit 204 (S214), and notifies the end processing unit 206 to newly obtain the pointer to the old data.

Meanwhile, the operations performed at S200 to S208 illustrated in FIG. 6 represent the details of the operation performed at S102 (manipulation target acquisition) illustrated in FIG. 5. Moreover, the operations performed at S210 to S214 illustrated in FIG. 6 represent the details of the operation performed at S132 (end processing) illustrated in FIG. 5.

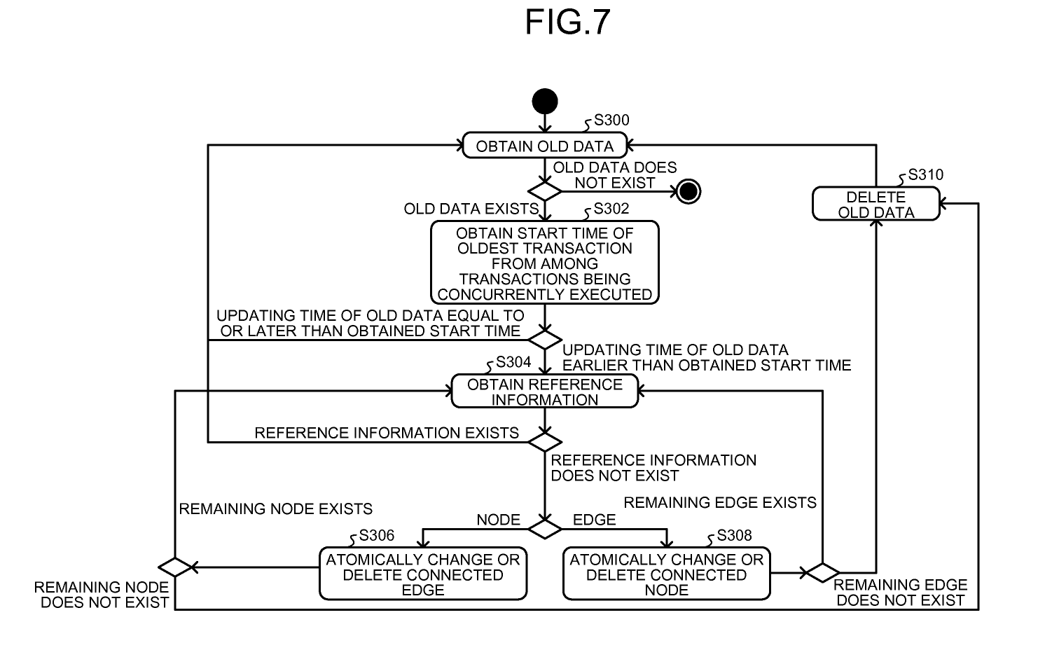

FIG. 7 is an activity diagram illustrating an example of operations performed in the terminal device 1 in the case of performing garbage collection. Firstly, the processing unit 20 obtains the old data (S300). When the old data does not exist, the processing unit 20 ends the operations. When the old data is present, the processing unit 20 notifies the determining unit 14 about the same.

Upon receiving the notification from the processing unit 20, the determining unit 14 obtains the start time of the oldest transaction from among the transactions that are being concurrently executed (S302). If the updating time of the old data is equal to or later than the start time, then the determining unit 14 notifies the processing unit 20 to obtain the old data. On the other hand, if the updating time of the old data is earlier than the start time, then the determining unit 14 obtains the reference information (S304).

When the reference information is present, the determining unit 14 notifies the processing unit 20 to obtain the old data. When the reference information does not exist, the determining unit 14 notifies the changing unit 16 about the same.

Upon receiving the notification from the determining unit 14, the changing unit 16 determines whether the reference information is about a node or an edge. If the reference information is about a node, then the changing unit 16 atomically changes or deletes the link information that is of the edge connected to the node and that points to the node (S306). When a remaining node exists, the changing unit 16 notifies the determining unit 14 to obtain the reference information. When no remaining node exists, the changing unit 16 notifies the deleting unit 18 about the same.

When the reference information is about an edge, the changing unit 16 atomically changes or deletes the link information that is of the node connected to the edge and that points to the edge (S308). When a remaining edge exists, the changing unit 16 notifies the determining unit 14 to obtain the reference information. When no remaining edge exists, the changing unit 16 notifies the deleting unit 18 about the same.

Upon receiving the notification from the changing unit 16, the deleting unit 18 deletes the old data and notifies the processing unit 20 to obtain a new piece of old data (S310).

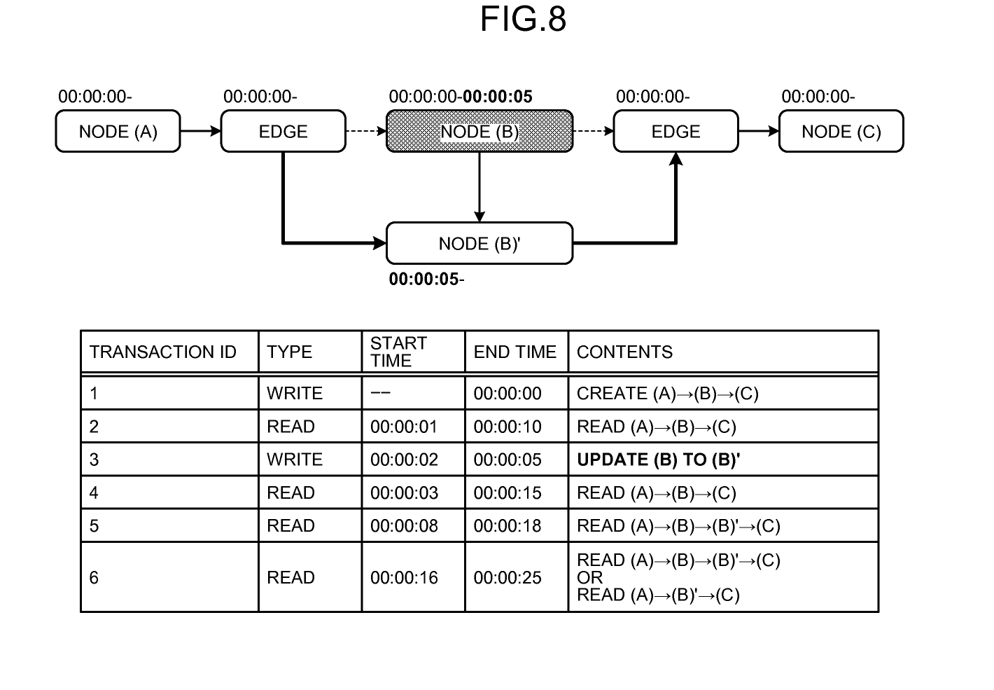

Given below is the explanation of a specific example of the operations performed in the terminal device 1. FIG. 8 is a diagram illustrating a specific example of the operations (a processing sequence) performed in the terminal device 1.

As illustrated in FIG. 8, firstly, simple graph data in the form of (A)→(B)→(C) is generated by a write transaction writeTx (1) that is completed at 00:00:00.

Herein, (B) is changed to (B)′ by a write transaction writeTx (3) that is executed from 00:00:02 to 00:00:05.

In this case, the operations of read transactions readTx (2), readTx (4), readTx (5) and readTx (6) are as given below.

The read transaction readTx (2) that is executed before the start of the write transaction writeTx (3) does not read (B)′.

The read transaction readTx (4) that is executed before the completion of the write transaction writeTx (3) also does not read (B)′.

After 00:00:05, (B) that has become old data cannot be deleted at the very least till the end time 00:00:15 of the write transaction readTx (4). That is guaranteed by the fact that the determining unit 14 obtains the start time of the oldest transaction from among the transactions being executed at that point of time (S302) and determines not to consider (B) as the target for deletion because the obtained start time (00:00:03) is earlier than the updating time (00:00:05) of the old data.

Meanwhile, the read transaction readTx (5) that is started after 00:00:05 reads (B) as well as (B)′. However, since the read start time (00:00:08) of the read transaction readTx (5) is later than the updating time (00:00:05) of the old data, the read transaction readTx (5) assigns reference information to (B).

Moreover, at the end time (00:00:18) thereof, the read transaction readTx (5) deletes the reference information. However, if the read transaction readTx (6) reads (B) before the end time (00:00:18), then the reference information assigned by the read transaction readTx (6) happens to remain. Hence, in this case, the read transaction readTx (5) does not drive the determining unit 14 (i.e., does not delete (B)).

If the read transaction readTx (6) reads (B) after 00:00:18, then the reference information of (B) becomes equal to zero at the end of the read transaction readTx (5). For that reason, the read transaction readTx (6) drives the determining unit 14 and deletes (B). Thus, in this case, the read transaction readTx (6) happens to read (A)→(B)′→(C).

On the other hand, if the read transaction readTx (6) reads (B) before 00:00:18, then it assigns reference information to (B). Thus, since the reference information happens to remain at the end, the read transaction readTx (5) cannot perform a retrieval operation with respect to (B) (cannot drive the determining unit 14). In this case, at the end time (00:00:25) of the read transaction readTx (6), the reference information of (B) becomes equal to zero. For that reason, the read transaction readTx (6) drives the determining unit 14 and deletes (B).

In this way, the terminal device 1 according to the embodiment detects that updating has been performed before the start of the oldest transaction from among the transactions being concurrently performed. Then, the link information of the edge which is connected to the node representing a graph element having no reference information assigned thereto is atomically changed. Moreover, the link information of all edges is changed to indicate post-updating nodes. Only then the graph element having no reference information assigned thereto is deleted. As a result, it becomes possible to read pre-updating data as well as to reduce the required memory size. That is, it also becomes possible to reduce the overhead of the memory usage required to ensure Repeatable read.

Meanwhile, in the embodiment described above, the configuration is such that the determining unit 14 is driven by the end processing unit. However, alternatively, the configuration can be such that the determining unit 14 is executed in a periodic manner. For example, the configuration can be such that the processing unit 20 registers the old data in the determining unit 14 during the commit completion state, and the determining unit 14 performs determination of the registered data in a periodic manner. In an identical manner, the detecting unit 202 can be configured to register the detected data in the determining unit 14, and the reference assigning unit 204 or the reference deleting unit 210 can be configured to register the old data, which has been assigned or deleted, in the determining unit 14.

An information processing program executed in the terminal device 1 according to the embodiment is recorded in the form of an installable or executable file in a computer-readable recording medium such as a compact disk read only memory (CD-ROM), a flexible disk (FD), a compact disk readable (CD-R), or a digital versatile disk (DVD).

Alternatively, the information processing program executed in the terminal device 1 according to the embodiment can be saved as a downloadable file on a computer connected to the Internet or can be made available for distribution through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal device comprising:
a memory unit configured to store therein graph elements each representing a node or an edge constituting graph structure data;
a managing unit configured to generate and delete a processing unit which executes transactions each performing data manipulation on an individual basis with respect to the graph elements stored in the memory unit;
a detector configured to detect that the graph element read by the processing unit is updated before the start of transaction being executed by the processing unit;
a reference assigning unit configured to assign reference information to the graph element detected by the detector;
a reference deleting unit configured to, at the end of a transaction which has performed manipulation with respect to the graph element having reference information assigned thereto by the reference assigning unit, delete the reference information assigned to the graph element which has been manipulated;
a determining unit configured to determine that a first graph element is updated before the start of the oldest transaction being executed and does not have reference information assigned thereto, the first graph element being pointed to by link information of a second information;
a changing unit configured to change the link information of the second graph element to point to a third graph element, or delete the link information; and
a deleting unit configured to delete the first graph element.

2. The device according to claim 1, wherein, when a number of pieces of reference information becomes equal to zero as a result of deletion of reference information by the reference information deleting unit, the determining unit performs determination with respect to the graph element.

3. The device according to claim 1, wherein the determining unit performs determination with respect to a target graph element for determination in a predetermined cycle.

4. The device according to claim 3, wherein the target graph element for determination is either one of a pre-updating graph element that is notified to the determining unit by the processing unit after updating is decided, a graph element that is detected by the detecting unit and notified to the determining unit, and a graph element that is notified to the determining unit by the reference assigning unit at the time of assigning or by the reference deleting unit at the time of deleting.

5. The device according to claim 1, wherein
the link information represents link information from an edge to a node, and
when an operation with respect to a node indicates deletion, the changing unit notifies the determining unit about an edge having the link information as a target for deletion.

6. An information processing method for storing data in a terminal device that includes a memory unit which stores therein graph elements each representing a node or an edge constituting graph structure data, the method comprising:
generating and deleting a processing unit which executes transactions each performing data manipulation on an individual basis with respect to the graph element stored in the memory unit;
detecting that the graph element read by the processing unit is updated before the start of transaction being executed by the processing unit;
assigning reference information to the graph element detected in the detecting;
deleting, at the end of a transaction which has performed manipulation with respect to the graph element having reference information assigned thereto, the reference information assigned to the graph element which has been manipulated;
determining that a first graph element is updated before the start of the oldest transaction being executed and does not have reference information assigned thereto, the first graph element being pointed to by link information of a second information;
changing the link information of the second graph element to point to a third graph element, or deleting the link information; and
deleting the first graph element.

7. A computer program product comprising a computer-readable medium containing an image processing program for storing data in a terminal device that includes a memory unit which stores therein graph elements each representing a node or an edge constituting graph structure data, wherein the program, when executed by a computer, causes the computer to perform:
generating and deleting a processing unit which executes transactions each performing data manipulation on an individual basis with respect to the graph element stored in the memory unit;
detecting that the graph element read by the processing unit is updated before the start of transaction being executed by the processing unit;
assigning reference information to the graph element detected in the detecting;
deleting, at the end of a transaction which has performed manipulation with respect to the graph element having reference information assigned thereto, the reference information assigned to the graph element which has been manipulated;
determining that a first graph element is updated before the start of the oldest transaction being executed and does not have reference information assigned thereto, the first graph element being pointed to by link information of a second information;
changing the link information of the second graph element to point to a third graph element, or deleting the link information; and
deleting the first graph element.
